(19) United States
(12) Patent Application Publication
(10) Pub. No.: US 2026/0038139 A1
(43) Pub. Date: Feb. 5, 2026

(54) POSE COMBINATION SYSTEMS AND METHODS

(71) Applicant: NAVER CORPORATION, Gyeonggi-do (KR)

(72) Inventors: Ginger DELMAS, Férolles-Attilly (FR); Philippe WEINZAEPFEL, Montbonnot-Saint-Martin (FR); Francesc MORENO-NOGUER, Sant Cugat del Valles (ES); Grégory ROGEZ, Gières (FR)

(73) Assignee: NAVER CORPORATION, Gyeonggi-do (KR)

(21) Appl. No.: 18/790,533

(22) Filed: Jul. 31, 2024

(51) Int. Cl. G06T 7/70; G06F 40/284; G06N 20/00; G06T 17/00

(52) U.S. Cl. CPC G06T 7/70; G06F 40/284; G06N 20/00; G06T 17/00; G06T 2207/20081; G06T 2207/20084; G06T 2207/30196

(57) ABSTRACT

A three dimensional (3D) pose determination system includes: a first multilayer perceptron (MLP) module configured to determine an image representation of a pose of the animal in an image; a second MLP module configured to determine a 3D pose representation of a 3D pose of the animal; a third MLP module configured to determine a text pose representation of a textual description of the pose of the animal; and a combination module configured to generate a final 3D pose representation of the pose of the animal based on at least one of the image representation, the 3D pose representation, and the text pose representation.

### FIELD

The present disclosure relates to three dimensional poses of animals and more particularly to systems and methods for generating combined poses of animals from information in multiple different modalities.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, a three dimensional (3D) pose determination system includes: an image encoder module configured to generate an image pose encoding based on an image including an animal; a first multilayer perceptron (MLP) module configured to determine an image representation of a pose of the animal in the image based on the image pose encoding; a pose encoder module configured to generate a 3D pose encoding based on an 3D pose of the animal; a second MLP module configured to determine a 3D pose representation of a pose of the animal in the 3D pose based on the 3D pose encoding; a text encoder module configured to generate a text pose encoding based on a textual description of a pose of the animal; a third MLP module configured to determine a text pose representation of the pose of the animal described by the textual description; and a combination module configured to generate a final 3D pose representation of the poses of the animal in the image, 3D pose, and the textual description based on at least one of the image representation, the 3D pose representation, and the text pose representation.

In further features, the combination module is configured to determine the final 3D pose representation further based on at least one of an image token, a 3D pose token, and a text token.

In further features, the combination module is configured to determine the final 3D pose representation further based on a learned global token.

In further features, the learned global token aggregates pose knowledge across textual descriptions of poses, 3D poses, and images including poses.

In further features, the image encoder module includes the Transformer architecture.

In further features, the image encoder module includes the DINOv2 image encoder.

In further features, the pose encoder module includes the VPoser encoder.

In further features, the text encoder module includes the Transformer architecture.

In further features, the text encoder module includes a model including the Transformer architecture and the DistilBERT text encoder.

In further features, the combination module includes the Transformer architecture.

In further features, the animal is a human and the 3D pose of the human is represented using joint parameters.

In further features, a control module is configured to, based on the final 3D pose representation, output a description of movement to be performed by the animal at least one of (a) visually on a display and (b) audibly via one or more speakers.

In further features, a control module is configured to actuate a robot based on the final 3D pose representation.

In further features, at least one of: a fourth MLP module is configured to determine a reconstructed image representation based on the final 3D pose representation corresponding to an image modality; a fifth MLP module is configured to determine a reconstructed 3D pose representation based on the final 3D pose representation corresponding to a 3D pose modality; and a sixth MLP module is configured to determine a reconstructed text representation based on the final 3D pose representation corresponding to a text pose modality, where each of the reconstructed image representation, the reconstructed 3D pose representation, and the reconstructed text representation are an embedding for querying a retrieval model corresponding to an input modality.

In further features, the reconstructed 3D pose representation is an augmented representation of input of a textual description together with input of a masked or incomplete image.

In further features, a head is configured to generate the 3D pose from the final 3D pose representation when the final 3D pose representation is derived from the image representation.

In further features, the final 3D pose representation is derived further from the text pose representation.

In further features, a training system includes a training module including: a fourth MLP module configured to determine a reconstructed image representation based on the final 3D pose representation; and an adjusting module configured to adjust at least one parameter of the image encoder module based on a difference between (a) the image representation and (b) the reconstructed image representation.

In further features, a training system includes a training module including: a fifth MLP module configured to determine a reconstructed 3D pose representation based on the final 3D pose representation; and an adjusting module configured to adjust at least one parameter of the pose encoder module based on a difference between (a) the 3D pose representation and (b) the reconstructed 3D pose representation.

In further features, a training system includes a training module including: a sixth MLP module configured to determine a reconstructed text pose representation based on the final 3D pose representation; and an adjusting module configured to adjust at least one parameter of the text encoder module based on a difference between (a) the text pose representation and (b) the reconstructed text pose representation.

In further features, a training system includes a training module including: a fourth MLP module configured to determine a reconstructed image representation based on the final 3D pose representation; a fifth MLP module configured to determine a reconstructed 3D pose representation based on the final 3D pose representation; a sixth MLP module configured to determine a reconstructed text representation based on the final 3D pose representation; and an adjusting module configured to selectively adjust parameters of the image encoder module, the pose encoder module, and the text encoder module based on the reconstructed image, 3D pose, and text representations.

In further features, the adjusting module is configured to selectively adjust the parameters of the image encoder module, the pose encoder module, and the text encoder module with the combination module frozen.

In further features, the adjusting module is configured to selectively adjust parameters of the combination module while the image encoder module, the pose encoder module, and the text encoder module are frozen after the adjustment of the parameters of the image encoder module, the pose encoder module, and the text encoder module.

In a feature, a three dimensional (3D) pose determination method includes: generating an image pose encoding based on an image including an animal; determining an image representation of a pose of the animal in the image based on the image pose encoding; generating a 3D pose encoding based on an 3D pose of the animal; determining a 3D pose representation of a pose of the animal in the 3D pose based on the 3D pose encoding; generating a text pose encoding based on a textual description of a pose of the animal; determining a text pose representation of the pose of the animal described by the textual description; and generating a final 3D pose representation of the poses of the animal in the image, 3D pose, and the textual description based on at least one of the image representation, the 3D pose representation, and the text pose representation.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 and 2 are functional block diagrams of example robots;

FIG. 3 includes a functional block diagram of an example training system;

FIG. 4 is a functional block diagram of an example implementation of a pose module;

FIG. 5 illustrates a functional block diagram of an example system illustrating the pose module and training;

FIG. 6 includes a functional block diagram of an example training system;

FIG. 7 includes an example illustration of three shadows produced by an object from three different points of view;

FIG. 8 illustrates an example text generating system;

FIG. 9 includes examples of poses and textual instructions that can be provided to instruct a human to move from a starting 3D pose (beginning of arrow) to a later 3D pose (point of arrow);

FIG. 10 includes example textual descriptions of rendered 3D poses and poses of humans in images;

FIG. 11 includes a flowchart depicting an example method of generating final 3D pose representations of humans;

FIG. 12 is a flowchart depicting an example method of training the pose module; and

FIG. 13 is an example illustration where images and text are used to render a 3D pose of a human.

In the drawings, reference numbers may be reused to identify similar and/or identical elements.

### DETAILED DESCRIPTION

A robot may include a camera. Images from the camera and measurements from other sensors of the robot can be used to control actuation of the robot, such as propulsion, actuation of one or more arms, and/or actuation of a gripper. For example, a pose can be determined, and a control module may actuate the robot to achieve the pose.

The present application involves a novel human pose representation that combines information from various different modalities, such as three dimensional (3D) pose (e.g., represented by SMPL (Skinned Multi-Person Linear Model) with pose parameters that describe joint rotations and shape parameters that describe body variations), textual description (e.g., in natural language), or visual information, such as an image/photograph. A pose module encodes each available modality using a dedicated encoder and feeds the encodings into a model (e.g., having the Transformer architecture) together with a learned token. This token serves to aggregate information across blocks (e.g., transformer blocks). A training module trains the pose module based on objective is defined by contrastive losses between a learned reprojection from the aggregated representation to the original modalities.

There exists no work that tackles the problem of compositional representation in the case of potentially partial subset of modalities. This is even more the case for human pose representation. In the context of User-Created Content service, one user may want to include a picture of a human or get a 3D pose among a large potential collection in which he/she is looking for a particular sample. Edited retrieval may additionally allow to edit intuitively such a sample. Mapping text and human poses can allow intuitive interfaces for human-robot interaction, to control a humanoid robot (with arms/legs) with voice or text or for other application, e.g. to automatically provide feedback during exercising. Automatically producing instructions to modify one's posture could open the door to endless applications, such as personalized sport coaching and in-home physical therapy. Tackling the reverse problem (refining a 3D pose based on some natural language feedback) could help for assisted 3D character animation, for example, in the context of the MetaVerse.

Aligning multiple modalities in a latent space, such as images and texts, has produces powerful semantic visual representations, fueling tasks like image captioning, text-to-image generation, and image grounding. In the context of human-centric vision, CLIP-like representations may encode most standard human poses (e.g., standing or sitting) relatively well, detailed or uncommon poses may be difficult. Actually, while 3D human poses may be associated with images (e.g. to perform pose estimation pose-conditioned image generation), or with text, 3D human poses are not paired with both images and text. The present application involves combining 3D poses with human images and textual pose descriptions to produce an enhanced 3D-, visual- and semantic-aware human pose representation.

The present application may involve a transformer architecture based model trained in a retrieval fashion, which can take as input any combination of the aforementioned modalities. When composing modalities, the model outperforms a standard multi-modal alignment retrieval model, making it possible to sort out partial information (e.g., image with the lower body occluded). The pose representations generated may be used in various applications, such as instruction generation, which involves generating text that describes how to move from one 3D pose to another (e.g., as a fitness coach).

Humans play a central role in many applications across a wide range of domains, including robotics, digitization (e.g., virtual avatars), and entertainment. In many of contexts, the human pose is a defining characteristic. While pose may predicted or estimated, for example, to further facilitate human-robot interaction, pose may be generated, such as to enhance experiences in video games or virtual worlds. This demonstrates the crucial importance of human understanding.

Human understanding goes beyond mere perception. It also relies on meaning, that is, semantics. Humans may tend to prefer when the world's semantics match ours. This is where natural language comes into play. Language empowers the conveyance of complex and abstract concepts; making it possible to gather similar elements together under the same word. For instance, one person could have their hand at shoulder level, and another person their hand way overhead; yet, both individuals could be “waving”. Ultimately, both visual and textual data are helpful to achieve human understanding: they are two facets of the same prism. However, both are imperfect: visual data may exhibit occlusions or depth uncertainty, while text is relatively ambiguous. Despite these flaws, they provide crucial information that a 3D pose alone could not convey, such as world affordance, reality anchoring, and semantics. All three modalities (visual data (e.g., images), textual description of poses, and 3D poses) can be considered complementary—partial, yet valuable—observations of the same abstract “human pose” concept.

The present application generates a rich pose embedding that is simultaneously semantic-, visual-and 3D-aware, by embroidering encodings of images, texts and 3D poses together. A transformer architecture based model may be used to aggregate information from available modalities within a single global token. The model is trained with unimodal contrastive objectives, on the reprojections of this global representation to each modality space. As a result, any single modality embedding fed to the model can be enhanced with knowledge from other modalities. The generated pose representation may be used with the task of any-to-any multi-modal retrieval, pose instruction generation (e.g., producing text that specifies how to modify one pose into another), robot actuation to achieve a generated pose, and other tasks. The present application and the multi-modal representation makes it possible to process direct camera input without the need for additional retraining. While the example of pose generation is provided, the present application is also applicable to retrieval of text, poses, or images from a database based on a combination of modalities, text generation, and other tasks.

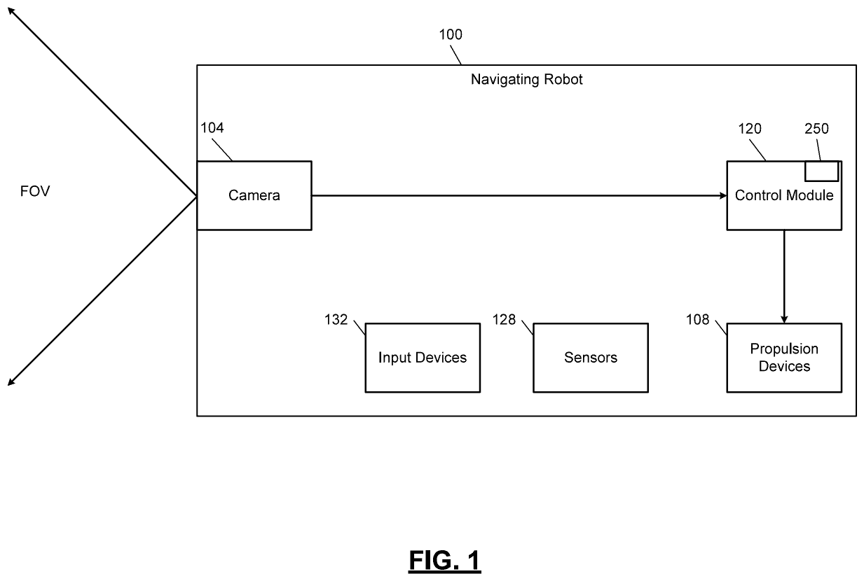

FIG. 1 is a functional block diagram of an example implementation of a navigating robot 100. The navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces. In various implementations, the camera 104 may be a binocular camera, or two or more cameras may be included in the navigating robot 100.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The navigating robot 100 is powered, such as via an internal battery and/or via an external power source, such as wirelessly (e.g., inductively).

While the example of a navigating robot is provided, the present application is also applicable to other types of robots with a camera.

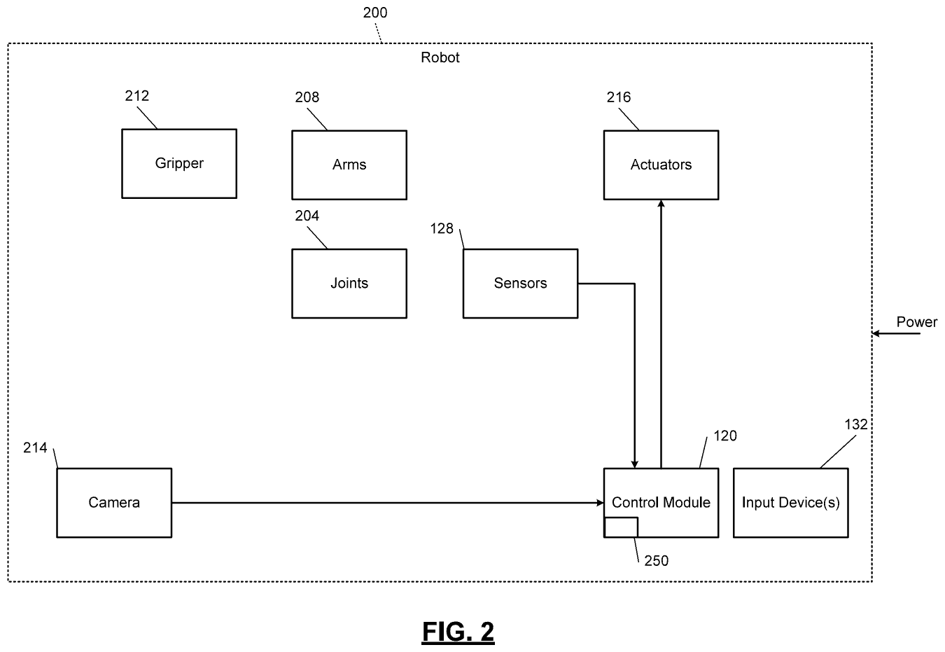

For example, FIG. 2 includes a functional block diagram of an example robot 200. The robot 200 may be stationary or mobile. The robot 200 may be, for example, a 5 degree-of-freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini cheetah robot, or another suitable type of robot. The robot 200 may be a humanoid robot in various implementations.

The robot 200 is electrically powered, such as via an internal battery and/or via an external power source, such as alternating current (AC) power. AC power may be received via an outlet, a direct cabled connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi-fingered) gripper 212 of the robot 200. The robot 200 includes actuators 216 that actuate the arms 208 and the gripper 212. The actuators 216 may include, for example, electric motors and other types of actuation devices.

In the example of FIG. 1, a control module 120 controls actuation of the propulsion devices 108. In the example of FIG. 2, the control module 120 controls the actuators 216 and therefore the actuation (movement, articulation, actuation of the gripper 212, etc.) of the robot 200. The control module 120 may include a planner module configured to plan movement of the robot 200 to perform one or more different tasks. An example of a task includes moving to and grasping and moving an object. The present application, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency. In various implementations, the camera 214 may be a binocular camera, or two or more cameras may be included in the robot 200.

The control module 120 controls actuation of the robot based on one or more images from the camera. The control module 120 may control actuation additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, a microphone, and/or one or more other suitable types of input devices.

While the example of a camera in a robot is provided, the present application is also applicable to cameras and other devices, such as standalone cameras, cameras of smart phones, cameras of tablet devices, cameras of laptops, cameras of wearable smart devices (e.g., watches, glasses), and other devices including or connected to a camera.

A pose module 250 (e.g., of the control module 120) determines a 3D pose of an animal (e.g., a human). While the example of a human will be described in the following, the present application is also applicable to other types of animals. As discussed further below, the pose module 250 determines the 3D pose of a human based on one, two, or all of (a) an image including at least a portion of the human, (b) 3D pose of the human, and (c) text describing a pose of the human.

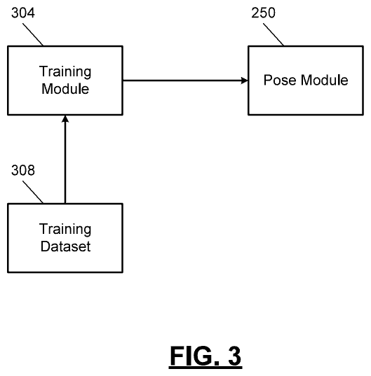

FIG. 3 is a functional block diagram of an example training system. A training module 304 trains the pose module 250 using a training dataset 308 as discussed further below.

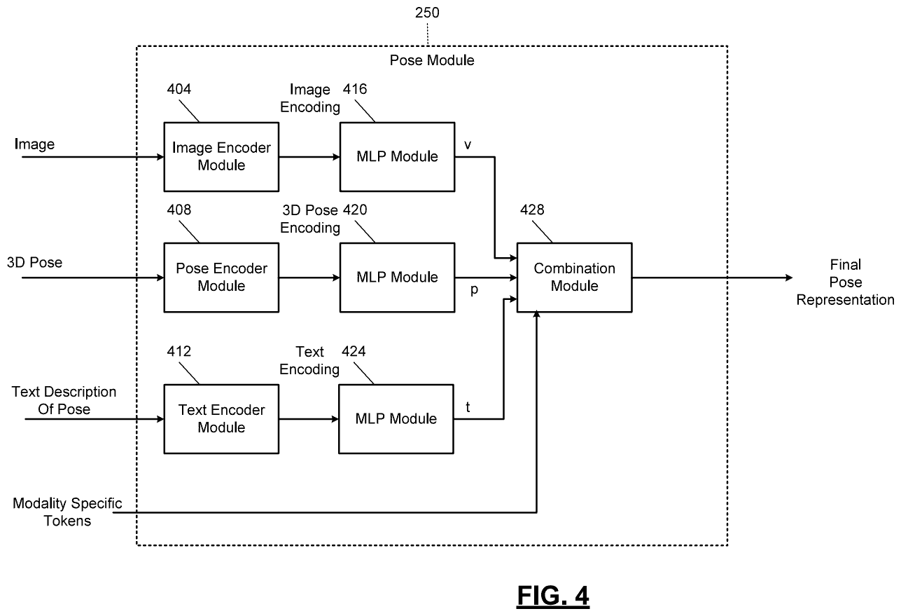

FIG. 4 is a functional block diagram of an example implementation of the pose module 250. The pose module 250 includes an image encoder module 404, a pose encoder module 408, and a text encoder module 412.

The image encoder module 404 generates an image encoding (representation) based on a 3D pose of a human in an image from a camera. The image encoding may be, for example, a vector or a matrix indicative of the 3D pose of the human in the image. In various implementations, the image encoder module 404 may have or be based on the Transformer architecture. Transformer architecture as used herein is described in Ashish Vaswani, Noam Shazeer, Niki Parmar, Jakob Uszkoreit, Llion Jones, Aidan N Gomez, Łukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present application is also applicable to the use of other types of attention mechanisms. For example, the image encoder module 404 may include the DINOv2 image encoder as described in M. Oquab, et al., Dinov2: Learning Robust Visual Features Without Supervision, TMLR, 2023, which is incorporated herein in its entirety. The present application is also applicable to other image encoders. In various implementations, the smpler-x/vision transformer architecture may be used.

The pose encoder module 408 generates a pose encoding (representation) based on a 3D pose of a human. The 3D pose may be, for example, determined based on input from one or more sensors, retrieved from memory, determined based on a rendering of the human, or received in another suitable manner. The pose encoding may be, for example, a vector or a matrix indicative of the 3D pose of the human in the 3D. For example, the pose encoder module 408 may include the VPoser encoder as described in G. Pavlakos, Expressive Body Capture: 3D Hands, Face, and Body from a Single Image, CVPR, 2019, which is incorporated herein in its entirety. The present application is also applicable to other 3D pose encoders.

The text encoder module 412 generates a text encoding (representation) based on a text describing a 3D pose of a human. The text may be received based on user input, such as text from speech received via a microphone, handwritten text input, scanned text, text input from an input device (e.g., a keyboard), or in another suitable manner. For example, the text encoder module 412 may include the DistilBERT text encoder as described in V. Sanh, Distilbert, A Distilled Version of BERT: Smaller, Faster, Cheaper, and Lighter, arXiv:1910.01108, 2019, which is incorporated herein in its entirety. The present application is also applicable to other text encoders.

A multilayer perceptron (MLP) module 416 generates an image representation (v), such as a vector or a matrix, based on the image encoding. A MLP module 420 generates a pose representation (p), such as a vector or a matrix, based on the pose encoding. A MLP module 424 generates a text representation (t), such as a vector or a matrix, based on the text encoding.

A combination module 428 generates a final 3D pose representation (x̅) of the human, such as a vector or a matrix, based on the image, pose, and text representations (v, p, t) and a learned token x and learned modality specific tokens e (i.e., eᵥ, eₚ and eₜ). In other words, the combination module 428 combines the received representations and the learned tokens to generate the final 3D pose representation of the human. In various implementations, only one or only two of the representations (and their respective learned tokens) may be input and used to generate the final 3D pose representation.

One or more actions may be taken based on the final 3D pose representation. For example, the control module 120 may actuate the robot based on the final 3D pose representation, such as to avoid contacting the human or to articulate the robot to achieve the pose of the final 3D pose representation. Another example includes a control module outputting (e.g., visually or audibly) a textual description (e.g., on a display and/or via one or speakers) of how a human should move to achieve a target 3D pose (e.g., based on a difference between the final 3D pose and the target 3D pose). In the example of a name of the human being known, the control module may output the name of the human to increase an experience of the human to the provided movement instruction. An example of a textual output that could be output to instruct a specific movement to a user named Shannon includes “Shannon, hold your head higher.”

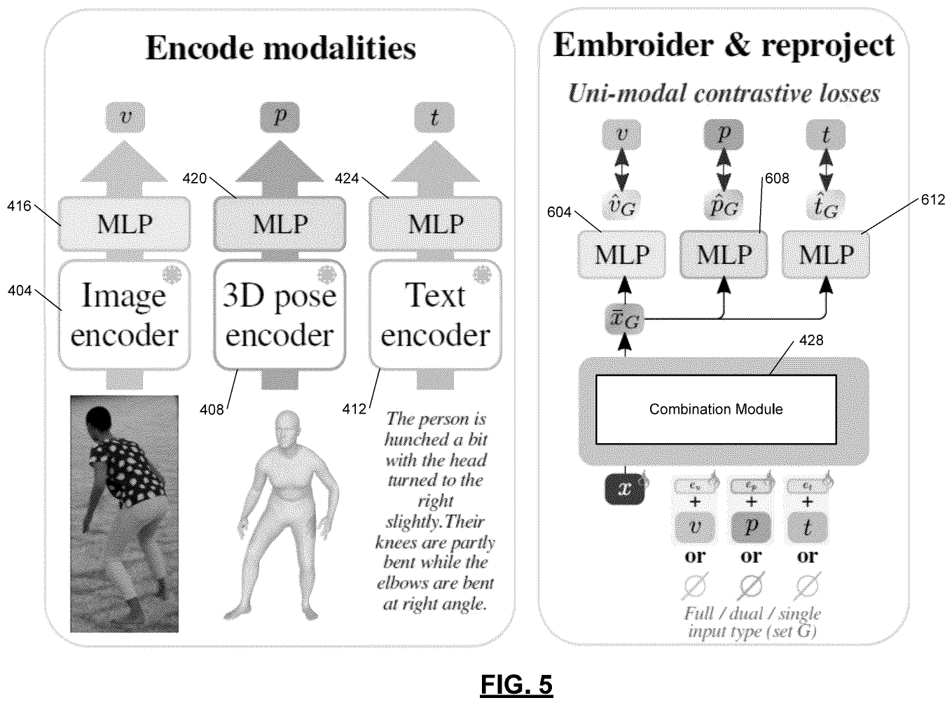

Generally speaking, each modality is encoded independently by an encoder. The combination module 428 may include a model based on or including the Transformer architecture taking a varying set of modality inputs. The combination module 428 produces a visual-, 3D-, semantic-aware pose representation x̅, by combining together available inputs. As discussed further below, the combination module 428 may be trained using uni-modal contrastive losses between the modality-specific reprojections \hat{m}∈{\hat{v}, \hat{p}, \hat{t}} of x̅ and the original encodings m∈{v, p, t}. The total objective function accounts for various x̅_{G} obtained from the full set or partial subsets G of input modalities. x and eₘ are learnable tokens, ‘+’ denotes an addition in FIG. 5. FIG. 5 illustrates a functional block diagram of an example system illustrating the pose module 250 and training. Advantageously, the pose module is configured to complete missing or partially observed modalities. In FIG. 5, elements with flames denote they are trained and elements with snowflakes denote they are frozen during training.

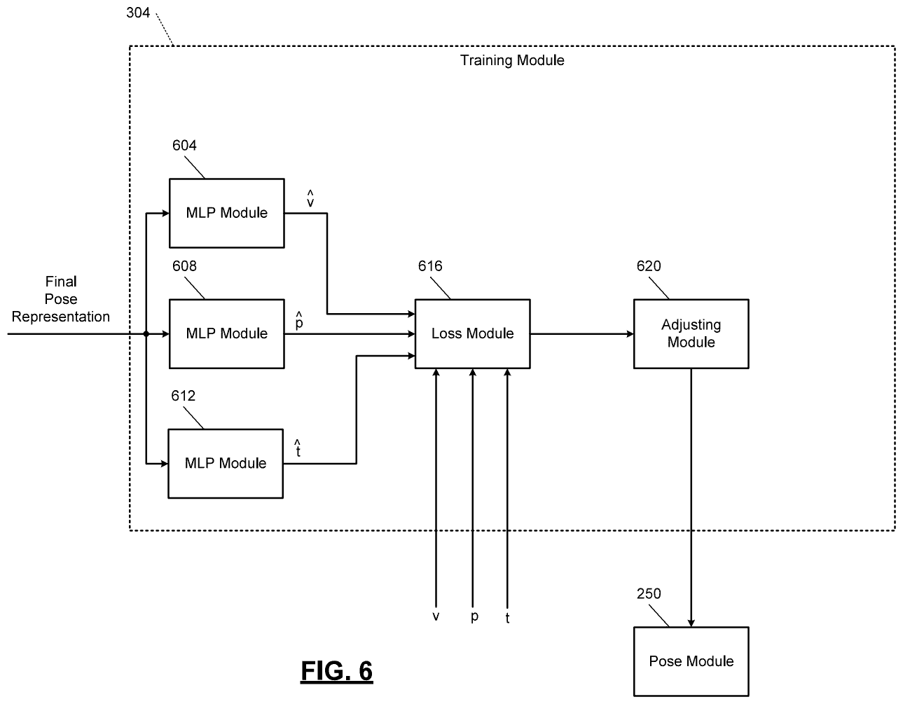

FIG. 6 includes a functional block diagram of an example training system. A multilayer perceptron (MLP) module 604 generates a reproduced image representation (\hat{v}), such as a vector or a matrix, based on the final 3D pose representation. The MLP module 604 may have the same architecture as the MLP module 416 such that the reproduced image representation (\hat{v}) can be compared with the image representation (v).

A MLP module 608 generates a reproduced pose representation (\hat{p}), such as a vector or a matrix, based on the final 3D pose representation. The MLP module 608 may have the same architecture as the MLP module 420 such that the reproduced pose representation (\hat{p}) can be compared with the image representation (p).

A MLP module 612 generates a reproduced text representation (\hat{t}), such as a vector or a matrix, based on the final 3D pose representation. The MLP module 612 may have the same architecture as the MLP module 424 such that the reproduced text representation (\hat{t}) can be compared with the text representation (t). In the example of image, text, or pose retrieval, the reproduced representations (\hat{v}), (\hat{p}), (\hat{t}) may be embeddings input to a retrieval model to determine search results (text, pose, or image). In the example of edited/augmented retrieval, a masked image or an image with missing information plus text that describes what it missing is input, and the embeddings are used by the retrieval model to retrieve one or more relevant poses.

Regarding parameter based regression with optional descriptive text (hint), one or more of the MLP modules 604-612 and/or the combination module 428 may include a head that is trained to regress pose parameters from the final pose representation from images only. At runtime/inference, the final pose representation may be obtained from an image only or an image and a textual description.

A loss module 616 determines a contrastive loss based on (a) a first mathematical difference between the reproduced image representation (\hat{v}) and the image representation (v), (b) a second mathematical difference between the reproduced pose representation (\hat{p}) and the image representation (p), and (c) a third mathematical difference between the reproduced text representation (\hat{t}) can be compared with the text representation (t). Additionally or alternatively, the loss module 616 may determine or more reconstruction losses, such as L2 or L1 loss for training.

An adjusting module 620 adjusts one or more parameters of the combination module 428 and the encoder modules 404-412 based on the contrastive loss (and/or the one or more reconstruction losses), such as based on minimizing the contrastive loss.

The training module 304 feeds samples including one or more of the modalities from the training dataset 308 into the pose module 250 for the training. Each sample results in one instance of the contrastive loss. The loss module 616 may determine a final contrastive loss based on the individual contrastive losses determined based on the feeding in of a predetermined number (e.g., 1,000, 5,000, etc.) of samples. The adjusting module 620 may adjust one or more parameters of the pose module 250 (e.g., the combination module 428 and the encoder modules 404-412) based on the final contrastive loss, such as based on minimizing the final contrastive loss.

The following describes the framework for learning multi-modal enhanced pose representations (final 3D pose representations). The overall design does not rely on specific types or numbers of modalities considered and allows for extension to other types and sets of modalities. As discussed above, this present application discusses the examples of three modalities: images of people, 3D human poses (e.g., parameterized by the rotations of the main SMPL body joints), and text descriptions of poses (e.g., in the form of fine-grained pose descriptions in natural language). Each modality provides different kinds of information, be it visual, spatial and kinematic, or semantic. The combination module 428 leverages the individual modality representations of the same abstract concept of human pose, to build a richer pose representation (the final 3D pose representation). SMPL is described in M. Loper, et al., SMPL: A Skinned Multi-Person linear Model, ACM TOG, 2015.

The training dataset 308 may include a tri-modal dataset with samples containing all modalities.

As discussed above, the image encoder module 404 may include or be based on the DINOv2 encoder, the pose encoder module 408 may include or be based on the VPoser encoder, and the text encoder module 412 may include or be based on a transformer architecture and the DistilBERT. If the image encoder was self-supervised on general in-the-wild images, it may lack specific acuteness in perceiving people. In particular, this model may be trained to produce invariant global image representations with respect to horizontal flipping. This may pose a complication when it comes to human pose understanding, as it may prevent distinction of the left and right body sides. The training module 304 may therefore finetune train the image encoder on human images without considering flipping for data augmentation. In order to reinforce human-centric perception, the training module 304 may train the image encoder module via contrastive learning. After this pretraining stage, the encoder modules may be kept frozen by the training module 304, and the training module 304 may then train the combining module 428 with the encoder modules frozen, such as based on a minimizing a difference between an expected final pose representation given an input sample and the final pose representation generated based on that input sample.

Generally speaking, each modality input is first processed by its respective frozen pretrained encoder module, then fed to a modality-specific learnable multi-layer perceptron module that further selects pose-related features and filters out pose-irrelevant details (e.g., background information in images).

Let v, p and t in [symbol] denote the corresponding outputs for the image, pose and text of a data triplet respectively. In the following, m may refer to any set of one or more of the modalities m∈M:={v, p, t}. The combination module 428 includes a model with the Transformer architecture. It takes a variable set of input modalities G∈S, and a learnable global token x, that collects and aggregates pose knowledge across all input modalities through the attention mechanisms of the model with the Transformer architecture.

The present application considers any combination of input modalities, i.e., S:={{v}, {p}, {t}, {v, p}, {v, t}, {p, t}, {v, p, t}}. For instance {v, p, t}, corresponds to the input all of different modalities. A stated above by S, two modality input and single modality input types are also considered. The combination module 428 is provided with {x}∪G, where a modality-specific learnable token eₘ∈R_{d} is added to (e.g., concatenated with) each input modality encoding in order to inform the model with the transformer architecture about the encoding nature. This is similar to learnable positional encoding.

The combination module 428 outputs |G|+1 tokens. Yet only the first token may be considered and used. The first token (the final 3D pose representation) may be denoted d x̅_{G}, which derives directly from the token x and holds specific information from G. The first token represents the richer, multi-modal informed pose embedding/representation. It can be obtained from any set of input modalities, and be used as main pose representation in downstream tasks.

Regarding the training, to ensure that x̅_{G} includes important visual, spatial & kinematic and semantic pose information, the training module may compare reconstructed outputs to each of the original unimodal representations. x̅_{G} is not directly compared with the individual modality representations as it would compel all modalities to live in the same space, and eventually lead to the collapse of x̅_{G} to a representation of common information between modalities. Instead, it is desirable for x̅_{G} to be an enhancement of its components. Even more, it is desirable for x̅_{G} to form sensible postulates for the modalities that did not directly contribute to derivation.

To train x̅_{G}, the training module 304 reprojects x̅_{G} back to the modality specific spaces/domains using the modality specific MLP modules 416-424. This yields \hat{m}_{G}∈\hat{ }\hat{M}_{G}={\hat{v}_{G}, \hat{p}_{G}, \hat{t}_{G}}.

For a given batch of B training samples, the loss module 616 may determine a final contrastive loss for each modality m, such as follows:

$${L}_{c} ( y , z ) = - \frac{1}{B} {\sum }_{i = 1}^{B} log \frac{exp ( γσ ( {y}_{i} , {z}_{i} ) )}{{\sum }_{j} exp ( γσ ( {y}_{i} , {z}_{j} ) )} \qquad ( 1 )$$

where γ is a learnable temperature parameter and σ is the cosine similarity function defined as:

$$σ ( y , z ) = \frac{{y}^{T} z}{‖ y ‖ ‖ z ‖} \qquad ( 2 )$$

Denoting M_{G:}={(m, \hat{m}_{G})|m∈M, \hat{m}_{G}∈\hat{M}_{G} of the same modality}, the loss module 616 may determine the total loss using the equation

$$L = {\sum }_{G ∈ S} {\sum }_{{M}_{G}} {L}_{c} ( m , {\hat{m}}_{G} ) \qquad ( 3 )$$

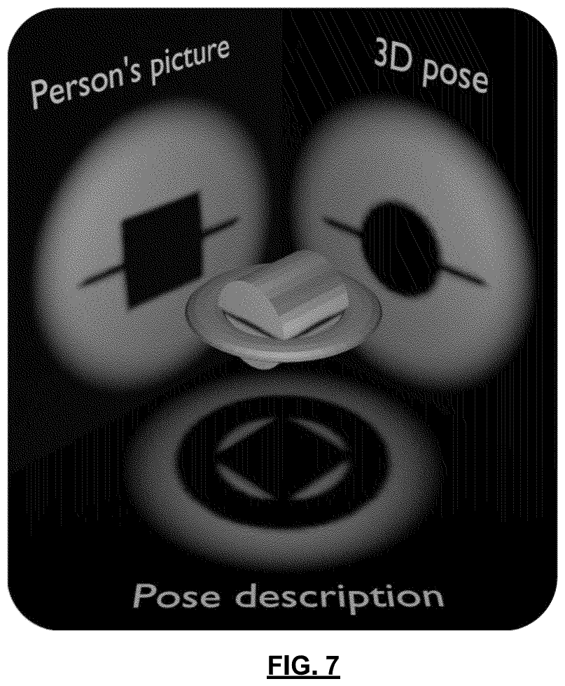

FIG. 7 includes an example illustration of three shadows produced by an object from three different points of view. The three shadows are similar to the modality specific representations discussed herein that are used to determine the final 3D pose representation, which here is represented by the image in the middle.

For example, the available shadows (G) can be used to determine the 3D object x̅_{G} using the combination module 428. FIG. 7 illustrates lighting the object from different angles to check shadow consistency in a soft way (L). Specifically, the shadows are not required to perfectly match (as it would be the case with a reconstruction loss): the ranking of the real object's shadow is enforced to be better than another object's shadow. During this validation, access to all ground-truth shadows is assumed: even if one or more modalities were missing from the input, as e.g. with {p}, the loss is applied on all available modalities. This forces x̅_{G} to be multi-modal aware, beyond being simply multi-modal informed. In other words, the combination module 428 provides a strong representation of any (potentially partial) combination of the modalities.

The training dataset 308 may include multi-modal data (e.g., including images, 3D poses, and text). In various implementations, one or more synthetic (generated) datasets may be used.

In various implementations, the training module 304 may first select a set of N diverse poses by farthest point sampling, i.e., sampling iteratively the pose that has the largest mean-per-joint distance with respect to the set of poses already selected.

If the training dataset 308 includes image-pose pairs, each pair may be augmented by the training module 304 with one or more detailed pose descriptions, such as using an automatic captioning algorithm. For example, given 3D joint coordinates, the training module 304 may determine a collection of posecodes informing about atomic pose configurations (e.g., bending of a body part, relative body part positioning, etc.). Those may be converted by the training module 304 to natural language description using a set of syntactic rules, merging posecodes that carry similar semantic information. This pipeline may also be improved to account for head rotations and self-contacts, so as to get better pose descriptions. This is made possible using a mesh rendering of the pose, and a self-contact detection algorithm coupled with a semantic segmentation of body vertices.

The pose module 250 trained as described herein produces convincing results on real-world data (images and texts).

Considered may be normalized 3D body poses, meaning with the global rotation set such that the hips are aligned and always facing in the same direction. This stems from the motivation to force the model to extract more general, world-anchored pose knowledge, in contrast to camera-dependent pose information. The 3D pose representations may be limited to the main 22 joints of the body in various implementations. Future work could additionally consider the hands, by also adapting the automatic captioning pipeline to provide such information.

The pose module 250 described herein outperforms other pose generators. This suggests that the pose module 250 enhances semantic pose representations. Notably, utilizing 3D pose inputs yields better results than 2D pose inputs.

In various implementations, each training image may include at least 16 of the main body joints within the image boundaries. This may improve performance of the training of the pose module 250. In various implementations, the person for which the pose is determined in each training image may be at the forefront (i.e., positioned closest to the camera compared to other individuals in the same image). In various implementations, training images may include a human behind the forefront if at least a predetermined percentage (e.g., 70%) of their bounding box does not overlap with the bounding box of a human positioned closer to the front.

In various implementations, at least one side of a human's bounding box (e.g., upscaled by a predetermined factor, such as 1.1) may be more than a predetermined number of pixels (e.g., 224 pixels). This may improve performance of the training.

In various implementations, the training module 304 may perform the training on truncated images input (instead of 3D poses only) and use text describing differences between the visible body parts. Two factors may make this conceivable. The pose module 250 may treat image and 3D pose input: it may provide a modality-agnostic representation to the text decoder (MLP module). Second, the model can be trained efficiently on synthetic data, using the automatic pipeline discussed above and may be modified to produce instructions involving a specific set of body joints (e.g., those visible in the images).

As discussed above, the pose encoder module 408 may be based on or include the VPoser encoder. In various implementations, the first layers may be different to account for the added global orientation, and the last layer may be replaced with a fully connected layer (FC), a rectified linear unit (ReLU), another FC layer, and L2-normalization. The pose encoder module 408 may output single-vector embeddings of size 512 for each given 3D pose (e.g., parameterized by the first 22 SMPL body joint rotations in axis-angle representation).

As discussed above, the text encoder module 412 may be based on or include model with the transformer architecture and the DistilBERT encoder. Text tokens may be embedded using the DistilBert encoder then fed to the model with the Transformer architecture (e.g., latent dimension 512, 4 heads, 4 layers, feed-forward networks of size 1024, GELU activations, dropout rate of 0.1). The final single-vector embedding of a text may be obtained by the text encoder module 412 average-pooling all its token encodings.

As discussed above, the image encoder module 404 may be based on or include the DINOv2 encoder or another architecture and use a predetermined number (e.g., 14) pixel sized patches, followed by a linear layer to project patch embeddings in a 512-dimensional space. The image encoder module 404 may average-pool the image tokens to derive the final single-vector image representation.

The modality specific MLP modules 416-420 may include small multi-layer perceptrons with 2 fully-connected layers of size 512 and a ReLU activation in-between. Their outputs may further be L2-normalized by the respective MLP modules 416-420. The same architecture for both the MLPs following the modality-specific encoders and the reprojection MLP modules 604-612 may be used.

The combination module 428 includes or is based on the Transformer architecture and includes, for example, latent dimension 512, 4 heads, 103 4 layers, feed-forward networks of size 1024, GELU activations, dropout rate of 0.1, followed by a LayerNorm. The learned tokens (x, eᵥ, eₚ and eₜ) may be learnable parameters of size 512. In various implementations, the combination module 428 may include a linear layer to project the 512 dimension to 256, run the transformer on 256 dimension, and finally have a linear layer to project back to 512 dimension.

The text encoder module 412 may receive encodings of size 512.

The pose encodings may be fused via a linear layer of dimension 512, then fed via cross-attentions to a transformer architecture decoder (e.g., latent dimension 512, 8 heads, 4 layers, feed-forward networks of size 1024, GELU activations, dropout rate of 0.1), which takes 512-dimensional token encodings as input. The output tokens may be given to a FC layer of the size of the vocabulary to predict the likelihood of each subsequent word.

Regarding optimization and training, The encoder modules 404-412 may be trained using retrieval models. The encoder modules 404-412 and the combination module 428 may be trained by the training module 304 using mini-batches of example size 128, an example learning rate of 2.10⁻⁴, the example of the Adam optimizer, and an example learning rate scheduler considering steps of example size 400 and an example gamma value of 0.5. The pose and text encoder modules 408 and 412 may be trained first by the training module 304 for the example of approximately 500 epochs, then the image encoder module trained with and based on the frozen pose encoder module for another approximately 100 epochs as an example. The training module 304 may train the combination module 428 for approximately epochs for example with the encoder modules 404-412 frozen.

The MLP module 612 may also be optimized by the training module 304 such as using the Adam optimizer with an example learning rate and weight decay of 10⁻⁴, for approximately 900 epochs as an example, and with example batch sizes of 64. The training module 304 may fine tune train the pose module 250 for example of 300 epochs. The training may be performed using precomputed cached features for the input pose representations.

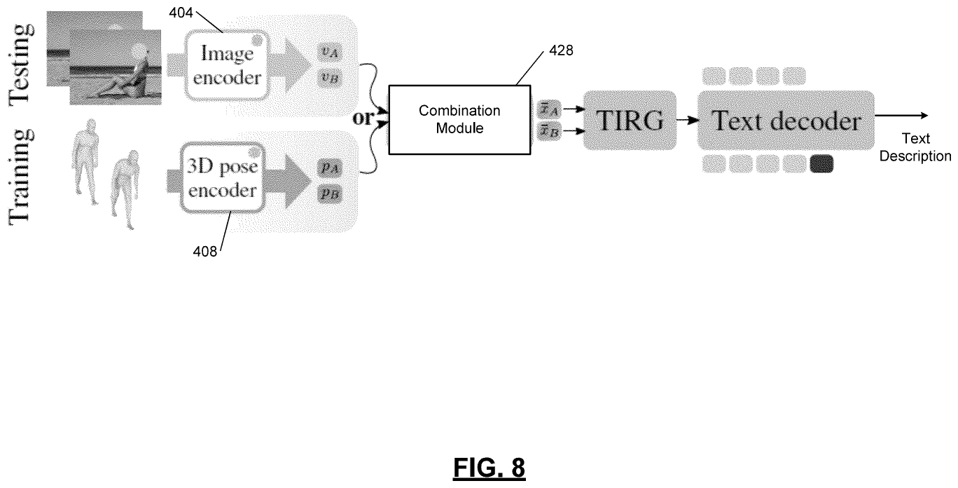

FIG. 8 illustrates an example text generating system. The training module 304 may train the pose module 250 based on pairs of poses (p_{A}, p_{B}) and use the frozen combination module 428 to generate final representations (x_{A}, x_{B}). A TIRG module fuses the two final representations and the output is used to condition an auto-regressive transformer text decoder with cross attentions. The text decoder decodes the output into a textual description of differences between the poses (p_{A}, p_{B}). The TIRG module is described, for example, in N. Vo, Composing Text and Image for Image Retrieval—an Empirical Odyssey, CVPR, 2019, which is incorporated herein in its entirety. At test time and thereafter, the trained pose module 250 can be directly applied to poses, images, or a combination of poses and images. In other words, training can be performed with only poses and the trained posed module 250 can be used to generate final poses for images, poses, or combinations of images and poses.

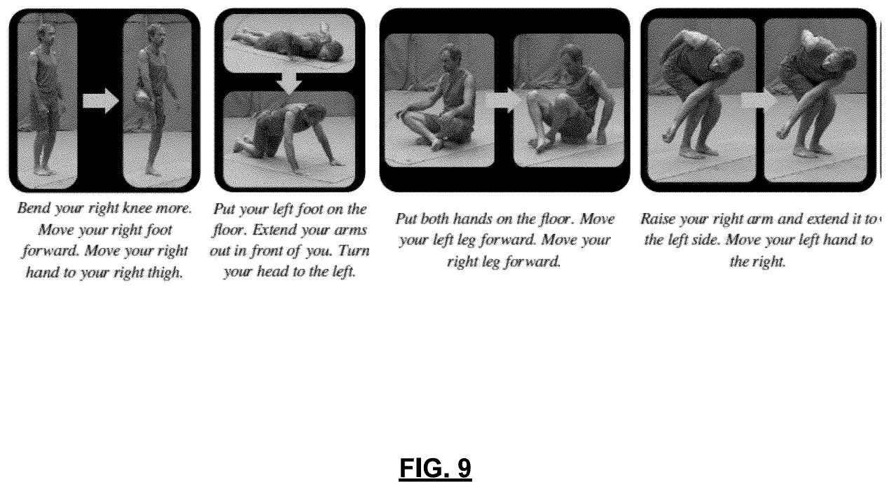

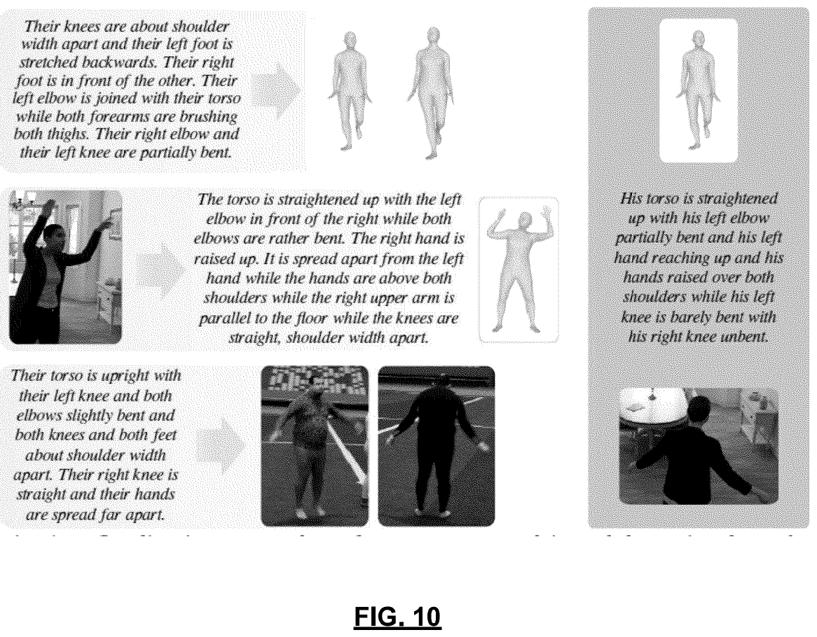

FIG. 9 includes examples of poses and textual instructions that can be provided to instruct a human to move from a starting 3D pose (beginning of arrow) to a later 3D pose (point of arrow). FIG. 10 includes example textual descriptions of rendered 3D poses and poses of humans in images.

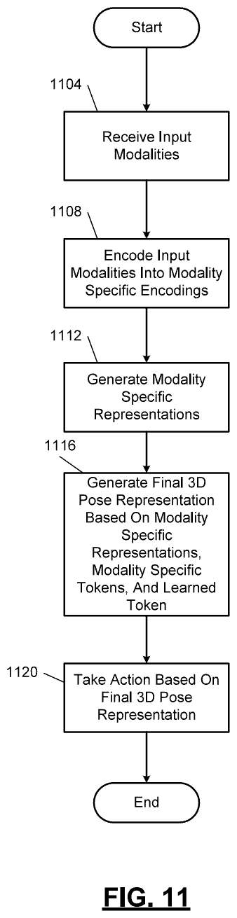

FIG. 11 includes a flowchart depicting an example method of generating final 3D pose representations of humans. Control begins fwith 1104 where the encoder modules 404-412 receive the respective modalities for poses, such as one or more of image, 3D poses, textual descriptions. At 1108, the encoder modules 404-412 encode the respective inputs into the modality specific encodings, respectively.

At 1112, the modality specific MLP modules 416-424 generate the modality specific representations based on the outputs of the respective encoder modules 404-412. At 1116, the combination module 428 generates a final 3D pose representation of the human in the input modalities based on the modality specific representations, the modality specific tokens, and the learned (global) token, as discussed above. At 1120, one or more actions may be taken based on the final 3D pose representation. For example, text description of movement to be performed by the human to move the final 3D pose representation of the human to a target 3D pose may be output visually on a display, audibly via one or more speakers, etc. As another example, a control module may actuate a robot to adjust a 3D pose of the robot toward or to the final 3D pose representation.

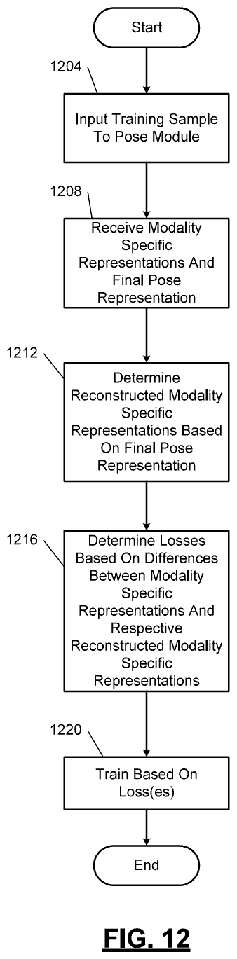

FIG. 12 is a flowchart depicting an example method of training the pose module 250. Control begins with 1204 where the training module 304 obtains a sample including one or more modalities of poses of a human to the pose module 250. The pose module 250 then proceeds as described above, such as with respect to FIG. 11.

At 1208, the training module 304 receives the final 3D pose representation of the human and the modality specific representations generated by the pose module 250 based on the input sample. At 1212, the MLP modules 604-612 determine reconstructed modality specific representations based on the final 3D pose representation. At 1216, the loss module 616 determines losses based on differences between the modality specific representations generated by the pose module 250 based on the input sample and the respective reconstructed modality specific representations from the MLP modules 604. For example, the loss module 616 determines a loss based on a difference between the image pose representation and the reconstructed image pose representation. The loss module 616 determines a loss based on a difference between the text pose representation and the reconstructed text pose representation. The loss module 616 determines a loss based on a difference between the 3D pose representation and the reconstructed 3D pose representation. As discussed above, however, one or more of the modalities may be omitted.

At 1220, the adjusting module 620 adjusts one or more parameters of the pose module based on one or more of the losses, as discussed above. For example, the adjusting module 620 may first train the encoder modules 404-412 with the combination module 428 frozen based on minimizing the losses. For example, the adjusting module 620 may train the image encoder module 404 based on minimizing a loss determined based on a difference between an image pose representation and the reconstructed image pose representation. The adjusting module 620 may train the pose encoder module 408 based on minimizing a loss determined based on a difference between an 3D pose representation and the reconstructed 3D pose representation. The adjusting module 620 may train the text encoder module 412 based on minimizing a loss determined based on a difference between a text pose representation and the reconstructed text pose representation. The adjusting module 620 may train the combination module 428 with the encoder modules 404-412 frozen after the training of the encoder modules 404-412.

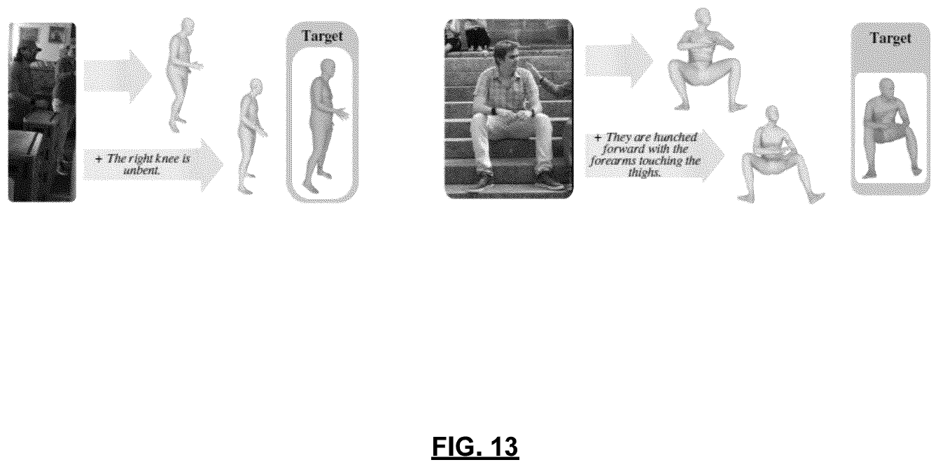

SMPL regression is an example use for the final 3D pose representations. SMPL regression (e.g., performed by a regression module) may generate a pose and shape parameters of the SMPL body model for a given input data of one or more modalities. This task may be referred to as 3D Human Mesh Recovery for an input image. The neural head may be trained as described above to predict SMPL parameters (e.g., final 3D pose representation) from pretrained, frozen features of the combination module. A network may be used to predict joint rotations from the mean parameters, and an MLP to regress shape coefficients. FIG. 13 is an example illustration where images and texts are used to render a 3D pose of a human.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A three dimensional (3D) pose determination system, comprising:
an image encoder module configured to generate an image pose encoding based on an image including an animal;
a first multilayer perceptron (MLP) module configured to determine an image representation of a pose of the animal in the image based on the image pose encoding;
a pose encoder module configured to generate a 3D pose encoding based on an 3D pose of the animal;
a second MLP module configured to determine a 3D pose representation of a pose of the animal in the 3D pose based on the 3D pose encoding;
a text encoder module configured to generate a text pose encoding based on a textual description of a pose of the animal;
a third MLP module configured to determine a text pose representation of the pose of the animal described by the textual description; and
a combination module configured to generate a final 3D pose representation of the poses of the animal in the image, 3D pose, and the textual description based on at least one of the image representation, the 3D pose representation, and the text pose representation.

2. The system of claim 1 wherein the combination module is configured to determine the final 3D pose representation further based on at least one of an image token, a 3D pose token, and a text token.

3. The system of claim 2 wherein the combination module is configured to determine the final 3D pose representation further based on a learned global token.

4. The system of claim 3 wherein the learned global token aggregates pose knowledge across textual descriptions of poses, 3D poses, and images including poses.

5. The system of claim 1 wherein the image encoder module includes the Transformer architecture.

6. The system of claim 1 wherein the image encoder module includes the DINOv2 image encoder.

7. The system of claim 1 wherein the pose encoder module includes the VPoser encoder.

8. The system of claim 1 wherein the text encoder module includes the Transformer architecture.

9. The system of claim 1 wherein the text encoder module includes a model including the Transformer architecture and the DistilBERT text encoder.

10. The system of claim 1 wherein the combination module includes the Transformer architecture.

11. The system of claim 1 wherein the animal is a human and the 3D pose of the human is represented using joint parameters.

12. The system of claim 1 further comprising a control module configured to, based on the final 3D pose representation, output a description of movement to be performed by the animal at least one of (a) visually on a display and (b) audibly via one or more speakers.

13. The system of claim 1 further comprising a control module configured to actuate a robot based on the final 3D pose representation.

14. The system of claim 1 further comprising at least one of:
a fourth MLP module configured to determine a reconstructed image representation based on the final 3D pose representation corresponding to an image modality;
a fifth MLP module configured to determine a reconstructed 3D pose representation based on the final 3D pose representation corresponding to a 3D pose modality; and
a sixth MLP module configured to determine a reconstructed text representation based on the final 3D pose representation corresponding to a text pose modality,
wherein each of the reconstructed image representation, the reconstructed 3D pose representation, and the reconstructed text representation are an embedding for querying a retrieval model corresponding to an input modality.

15. The system of claim 14 wherein the reconstructed 3D pose representation is an augmented representation of input of a textual description together with input of a masked or incomplete image.

16. The system of claim 11 further comprising a head to generate the 3D pose from the final 3D pose representation when the final 3D pose representation is derived from the image representation.

17. The system of claim 16 wherein the final 3D pose representation is derived further from the text pose representation.

18. A training system comprising:
the system of claim 1; and
a training module comprising:
a fourth MLP module configured to determine a reconstructed image representation based on the final 3D pose representation; and
an adjusting module configured to adjust at least one parameter of the image encoder module based on a difference between (a) the image representation and (b) the reconstructed image representation.

19. A training system comprising:
the system of claim 1; and
a training module comprising:
a fifth MLP module configured to determine a reconstructed 3D pose representation based on the final 3D pose representation; and
an adjusting module configured to adjust at least one parameter of the pose encoder module based on a difference between (a) the 3D pose representation and (b) the reconstructed 3D pose representation.

20. A training system comprising:
the system of claim 1; and
a training module comprising:
a sixth MLP module configured to determine a reconstructed text pose representation based on the final 3D pose representation; and
an adjusting module configured to adjust at least one parameter of the text encoder module based on a difference between (a) the text pose representation and (b) the reconstructed text pose representation.

21. A training system comprising:
the system of claim 1; and
a training module comprising:
a fourth MLP module configured to determine a reconstructed image representation based on the final 3D pose representation;
a fifth MLP module configured to determine a reconstructed 3D pose representation based on the final 3D pose representation;
a sixth MLP module configured to determine a reconstructed text representation based on the final 3D pose representation; and
an adjusting module configured to selectively adjust parameters of the image encoder module, the pose encoder module, and the text encoder module based on the reconstructed image, 3D pose, and text representations.

22. The training system of claim 21 wherein the adjusting module is configured to selectively adjust the parameters of the image encoder module, the pose encoder module, and the text encoder module with the combination module frozen.

23. The training system of claim 21 wherein the adjusting module is configured to selectively adjust parameters of the combination module while the image encoder module, the pose encoder module, and the text encoder module are frozen after the adjustment of the parameters of the image encoder module, the pose encoder module, and the text encoder module.

24. A three dimensional (3D) pose determination method, comprising:
generating an image pose encoding based on an image including an animal;
determining an image representation of a pose of the animal in the image based on the image pose encoding;
generating a 3D pose encoding based on an 3D pose of the animal;
determining a 3D pose representation of a pose of the animal in the 3D pose based on the 3D pose encoding;
generating a text pose encoding based on a textual description of a pose of the animal;
determining a text pose representation of the pose of the animal described by the textual description; and
generating a final 3D pose representation of the poses of the animal in the image, 3D pose, and the textual description based on at least one of the image representation, the 3D pose representation, and the text pose representation.
